(19) United States
(12) Patent Application Publication
(10) Pub. No.: US 2009/0015989 A1
(43) Pub. Date: Jan. 15, 2009

(54) SOLID ELECTROLYTIC CAPACITOR AND METHOD FOR PRODUCING THE SAME

(75) Inventors: Kazuhiro Takatani, Amagasaki-city (JP); Mutsumi Yano, Hirakata-city (JP); Takashi Umemoto, Hirakata-city (JP); Hiroshi Nonoue, Hirakata-city (JP)

Correspondence Address: MOTS LAW, PLLC, 1001 PENNSYLVANIA AVE. N.W., SOUTH, SUITE 600, WASHINGTON, DC, 20004, US

(73) Assignee: SANYO ELECTRIC CO., LTD, Moriguchi-city (JP)

(21) Appl. No.: 12/169,716

(22) Filed: Jul. 9, 2008

(30) Foreign Application Priority Data
Jul. 11, 2007 (JP) JP2007-181564

(51) Int. Cl. H01G 9/07

(52) U.S. Cl. 361/524; 29/25.03

(57) ABSTRACT

The invention provides a solid electrolytic capacitor which can suppress increase of a leakage current due to a heat load, and a method for producing the solid electrolytic capacitor. The solid electrolytic capacitor includes an anode body, a dielectric layer formed on a surface of the anode body, a conductive polymer layer formed on the dielectric layer, and a cathode layer formed on the conductive polymer layer. The dielectric layer contains at least one metal element which is selected from the group consisting of tungsten (W), molybdenum (Mo), vanadium (V) and chromium (Cr) and which has a concentration distribution in a direction of the thickness of the dielectric layer (i.e. in a direction from the cathode side to the anode side of the dielectric layer) so that the concentration of the metal element is maximized at an interface between the dielectric layer and the conductive polymer layer.

### BACKGROUND OF THE INVENTION

1. Field of the Invention

The present invention relates to a solid electrolytic capacitor and a method fox producing the same. Particularly it relates to a solid electrolytic capacitor using niobium or a niobium alloy as an anode material and a method for producing the same.

2. Description of the Related Art

Generally, a solid electrolytic capacitor is formed in such a manner that a cathode is formed on a dielectric layer which is mainly composed of oxide and which is formed on a surface of an anode of a valve metal such as niobium (Nb) or tantalum (Ta) by anodic oxidation of the anode. Particularly, niobium attracts attention as a material for a next-generation high-capacity solid electrolytic capacitor because the dielectric constant of niobium oxide is about 1.8 times as large as the dielectric constant of tantalum oxide in the case where tantalum which is a material for a solid electrolytic capacitor according to the related art is used.

Usually, the solid electrolytic capacitor may be exposed to a high temperature in a reflow soldering process when the solid electrolytic capacitor is mounted on a surface of a board. In a solid electrolytic capacitor using niobium or a niobium alloy as an anode material, there arises a phenomenon that part of amorphous niobium oxide functioning as a dielectric layer is crystallized by such a heat load. Since the volume of niobium oxide changes according to the change of state of niobium oxide from amorphous to crystal, the crystallization of niobium oxide is apt to cause cracks in the dielectric layer. As a result, short-circuiting is generated between the anode and the cathode to thereby cause a problem that a leakage current in the dielectric layer increases.

To suppress the increase of such a leakage current, there has been proposed a method in which an anode of niobium is anodized in an aqueous solution containing fluorine ions and then anodized in an aqueous solution containing phosphoric acid ions again to thereby make fluorine and phosphorus contained in a dielectric layer of niobium oxide (see JP-A-2005-252224).

### SUMMARY OF THE INVENTION

Although the method described in JP-A-2005-252224 can suppress the increase of the leakage current to a certain degree, a recent solid electrolytic capacitor requires more suppression of the leakage current.

The invention was accomplished in consideration of the aforementioned problem. An object of the present invention is to provide a solid electrolytic capacitor which can suppress increase of a leakage current caused by a heat load, and a method for producing the same.

To achieve the foregoing object, the solid electrolytic capacitor according to the invention includes: an anode made of niobium or a niobium alloy; a dielectric layer formed on a surface of the anode and containing niobium oxide; a cathode including a conductive polymer layer formed on the dielectric layer; wherein the dielectric layer contains at least one metal element which is selected from the group consisting of tungsten, molybdenum, vanadium and chromium and which is unevenly distributed so as to be lopsidedly inclined toward the cathode side. The term “lopsidedly inclined toward the cathode side” used herein means a state in which a region (maximum value) where the concentration distribution of the metal in the direction of the thickness of the dielectric layer is maximized is located on the cathode side in view from a half of the thickness of the dielectric layer.

To achieve the foregoing object, the method of producing a solid electrolytic capacitor according to the invention includes the steps of: a) performing anodic oxidation on a surface of an anode made of niobium or a niobium alloy in an aqueous solution containing metallic acid ions selected from the group consisting of tungstic acid ions, molybdic acid ions, vanadic acid ions and chromic acid ions to thereby form a dielectric layer containing niobium oxide and dope the dielectric layer with the metallic acid ions; and b) forming a cathode including a conductive polymer layer on the dielectric layer.

According to the invention, there can be provided a solid electrolytic capacitor which can suppress increase of a leakage current due to a heat load, and a method for producing the solid dielectric capacitor.

### BRIEF DESCRIPTION OF THE DRAWINGS

FIG. 1 is a schematic sectional view showing the configuration of a solid electrolytic capacitor according to an embodiment of the present invention;

FIG. 2 is a graph showing a result of measurement of a solid electrolytic capacitor according to Example 1 of the invention by XPS;

FIG. 3 is a graph showing a result of measurement of a solid electrolytic capacitor according to Example 9 of the invention by XPS;

FIG. 4 is a graph showing a result of measurement of a solid electrolytic capacitor according to Example 10 of the invention by XPS; and

FIG. 5 is a graph showing a result of measurement of a solid electrolytic capacitor according to Example 11 of the invention by XPS.

### DESCRIPTION OF THE PREFERRED EMBODIMENT

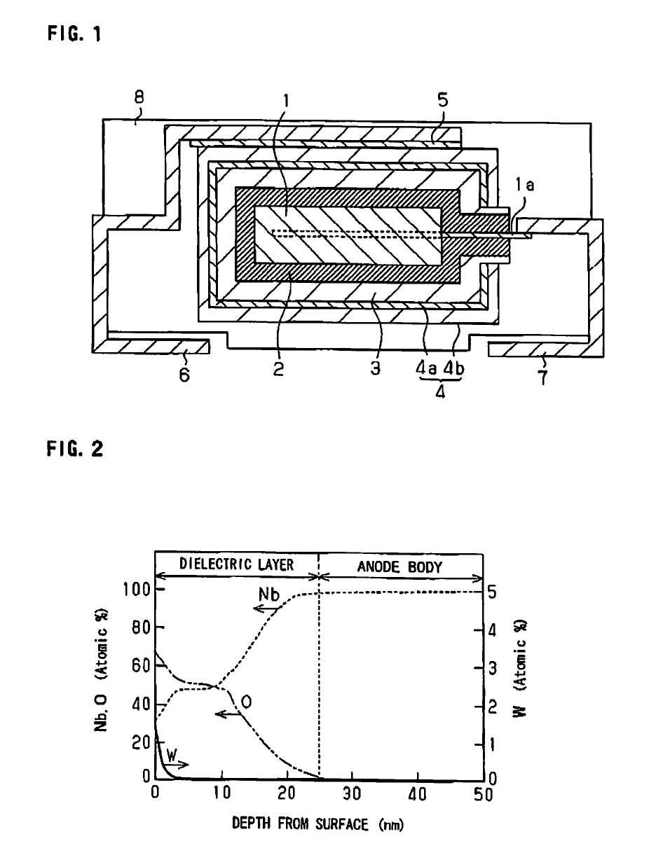

An embodiment of the present invention will be described below with reference to the drawings. Incidentally, the present invention is not limited to the embodiment. FIG. 1 is a schematic sectional view showing the configuration of a solid electrolytic capacitor according to this embodiment.

The solid electrolytic capacitor according to this embodiment includes an anode body 1, a dielectric layer 2 formed on a surface of the anode body 1, a conductive polymer layer 3 formed on the dielectric layer 2, and a cathode layer 4 formed on the conductive polymer layer 3.

The anode body 1 is mainly composed of a porous sintered substance of niobium metal particles. A part of an anode lead 1a made of niobium metal is embedded in the inside of the anode body 1. Incidentally, a niobium alloy may be used as the niobium which forms the anode body 1 and the anode lead 1a.

The dielectric layer 2 is composed of a dielectric made of niobium oxide (Nb₂O₅) which is oxide of niobium metal. The dielectric layer 2 is formed on surfaces of the anode body 1 and the anode lead 1a. In this embodiment, the dielectric layer 2 is doped with a metal element selected from the group consisting of tungsten (W), molybdenum (Mo), vanadium (V) and chromium (Cr), so that the metal element is unevenly distributed so as to be lopsidedly inclined toward the cathode side (conductive polymer layer 3 side) of the dielectric layer 2. Specifically, the metal element has a concentration distribution in a direction of the thickness of the dielectric layer 2 (i.e. in a direction from the cathode side to the anode side of the dielectric layer 2) so that the concentration of the metal element is maximized at an interface between the dielectric layer 2 and the conductive polymer layer 3.

The conductive polymer layer 3 functions as an electrolyte layer and is formed on a surface of the dielectric layer 2. Although the material of the conductive polymer layer 3 is not particularly limited as long as it is a polymer material having electrically conducting properties, there may be used a material excellent in electrically conducting properties such as polypyrrole, polyaniline, polythiophene, etc.

The cathode layer 4 is formed of a laminated film composed of a carbon layer 4a and a silver paste layer 4b and is provided on the conductive polymer layer 3. The carbon layer 4a is formed of a layer containing carbon particles. The silver paste layer 4b is formed of a layer containing silver particles. A cathode is formed due to the cathode layer 4 and the conductive polymer layer 3.

In this embodiment, a cathode terminal 6 shaped like a flat plate is further connected onto the cathode layer 4 through an electrically conductive adhesive agent 5 while an anode terminal 7 shaped like a flat plate is further connected to the anode lead 1a. A molded exterior part 8 made of an epoxy resin or the like is formed while the anode terminal 7 and the cathode terminal 6 are partially led to the outside as shown in FIG. 1. An electrically conductive material such as nickel (Ni) can be used as a material for the anode terminal 7 and the cathode terminal 6. Respective end portions of the anode terminal 7 and the cathode terminal 6 exposed from the molded exterior part 8 are bent so as to function as terminals of the solid electrolytic capacitor.

Incidentally, the anode body 1 is an example of the “anode” in the invention, the dielectric layer 2 is an example of the “dielectric layer” in the invention, the conductive polymer layer 3 is an example of the “conductive polymer layer” in the invention, the cathode composed of the conductive polymer layer 3 and the cathode layer 4 is an example of the “conductive polymer layer-including cathode” in the invention, and the metal element is an example of the “metal element” in the invention.

(Producing Method)

A method for producing a solid electrolytic capacitor according to this embodiment shown in FIG. 1 will be described next.

(Process 1) A molded body of niobium metal particles which is molded so that a part of the anode lead 1a is embedded therein is sintered in a vacuum to thereby form the anode body 1 of a porous sintered substance around the anode lead 1a. On this occasion, the niobium metal particles are fusion-bonded to one another.

(Process 2) The anode body 1 is anodized in an aqueous solution containing metallic acid ions selected from the group consisting of tungstic acid ions, molybdic acid ions, vanadic acid ions and chromic acid ions to thereby form the dielectric layer 2 mainly composed of niobium oxide so that the anode body 1 is covered with the dielectric layer 2. On this occasion, the dielectric layer 2 is doped with metallic acid ions. Such metallic acid ions (tungsten, molybdenum, vanadium or chromium which is a metal element forming metallic acid ions) are unevenly distributed so as to be lopsidedly inclined toward the cathode side of the dielectric layer 2 (i.e. an interface between the dielectric layer 2 and the conductive polymer layer 3).

(Process 3) The conductive polymer layer 3 of polypyrrole or the like is formed on a surface of the dielectric layer 2 by a chemical polymerization method, an electrolytic polymerization method, etc. Specifically, as a first step, monomer is oxidatively polymerized with an oxidizing agent by a chemical polymerization method to thereby form a first conductive polymer layer. Continuously, as a second step, electrolytic polymerization is performed between the first conductive polymer layer as an anode and an external cathode in an electrolyte solution containing a monomer and an electrolyte by an electrolytic polymerization method to thereby form a second conductive polymer layer. In this manner, the conductive polymer layer 3 made of a laminated film composed of the first conductive polymer layer and the second conductive polymer layer is formed on a surface of the dielectric layer 2.

(Process 4) Carbon paste is applied on the conductive polymer layer 3 and dried to thereby form a carbon layer 4a. Silver paste is further applied on the carbon layer 4a and dried to thereby form a silver paste layer 4b. In this manner, the cathode layer 4 made of a laminated film composed of the carbon layer 4a and the silver paste layer 4b is formed on the conductive polymer layer 3.

(Process 5) After an conductive adhesive agent 5 is applied on a flat plate-like cathode terminal 6, the conductive adhesive agent 5 is dried while the cathode layer 4 and the cathode terminal 6 come into contact with each other through the conductive adhesive agent 5 to thereby connect the cathode layer 4 and the cathode terminal 6 to each other. A flat plate-like anode terminal 7 is connected onto the anode lead 1a by spot welding.

(Process 6) A molded exterior part 8 made of an epoxy resin is formed on the outside by a transfer molding method. On this occasion, the molded exterior part 8 is formed so that while the anode lead 1a, the anode body 1, the dielectric layer 2, the conductive polymer layer 3 and the cathode layer 4 are contained in the inside, respective end portions of the anode terminal 7 and the cathode terminal 6 are led to the outside (in an opposite direction).

(Process 7) Front end portions of the anode terminal 7 and the cathode terminal 6 exposed from the molded exterior part 8 are bent downward and disposed along a lower surface of the molded exterior part 8. The front end portions of the two terminals function as terminals of the solid electrolytic capacitor and are used for electrically connecting the solid electrolytic capacitor to a mount board.

The solid electrolytic capacitor according to this embodiment is produced after the aforementioned processes.

### EXAMPLES

In the following examples and comparative examples, a solid electrolytic capacitor just after the formation of the cathode layer was produced and characteristic thereof was evaluated.

### Example 1

In Example 1, a solid electrolytic capacitor A1 was produced after processes corresponding to the respective processes (Process 1 to Process 4) in the aforementioned producing method.

(Process 1A) Niobium metal powder having a mean particle size of about 2 μm is molded so that a part of the anode lead 1a is embedded therein. It is sintered in a vacuum at 1200° C. for 20 minutes. In this manner, an anode body 1 made of a niobium porous sintered substance is formed.

(Process 2A) In an aqueous solution containing 0.1% by weight of sodium tungstate (Na₂WO₄) kept at about 60° C., the sintered anode body 1 is anodized at a constant voltage of about 10 V for about 10 hours. In this manner, a dielectric layer 2 mainly composed of niobium oxide and doped with tungsten is formed so that the anode body 1 is covered with the dielectric layer 2. Details will be described later. On this occasion, tungsten has a concentration distribution in a direction of the thickness of the dielectric layer 2 so that the concentration of tungsten will be maximized at an interface between the dielectric layer 2 and the conductive polymer layer 3.

(Process 3A) After the anode body 1 with the dielectric layer 2 formed thereon is immersed in an oxidizing agent solution, the anode body 1 is immersed in a pyrrole monomer liquid so that the pyrrole monomer is polymerized on the dielectric layer 2 (first step). In this manner, a first conductive polymer layer made of polypyrrole is formed on the dielectric layer 2.

Continuously, while the first conductive polymer layer is used as an anode, electrolytic polymerization is performed in an electrolyte solution containing a pyrrole monomer and an electrolyte to thereby further form a second conductive polymer layer with a predetermined thickness on the first conductive polymer layer (second step). In this manner, the second conductive polymer layer made of polypyrrole is formed on the first conductive polymer layer.

In this manner, the conductive polymer layer 3 made of a laminated film composed of the first conductive polymer layer and the second conductive polymer layer is formed on a surface of the dielectric layer 2.

(Process 4A) Carbon paste is applied on the conductive polymer layer 3 and dried to thereby form a carbon layer 4a having a layer containing carbon particles. Silver paste is further applied on the carbon layer 4a and dried to thereby form a silver paste layer 4b having a layer containing silver particles. In this manner, the cathode layer 4 made of a laminated film composed of the carbon layer 4a and the silver paste layer 4b is formed on the conductive polymer layer 3. Then, heat treatment is performed at 250° C. for 30 seconds.

As described above, the solid electrolytic capacitor A1 according to Example 1 is produced.

### Example 2

In Example 2, a solid electrolytic capacitor A2 was produced in the same manner as in Example 1 except that an aqueous solution containing 0.1% by weight of sodium molybdate (Na₂MoO₄) was used in place of the aqueous solution containing 0.1% by weight of sodium tungstate in the process 2A.

### Example 3

In Example 3, a solid electrolytic capacitor A3 was produced in the same manner as in Example 1 except that an aqueous solution containing 0.1% by weight of ammonium vanadate (NH₄VO₃) was used in place of the aqueous solution containing 0.1% by weight of sodium tungstate in the process 2A.

### Example 4

In Example 4, a solid electrolytic capacitor A4 was produced in the same manner as in Example 1 except that an aqueous solution containing 0.1% by weight of sodium chromate (Na₂CrO₄) was used in place of the aqueous solution containing 0.1% by weight of sodium tungstate in the process 2A.

### Example 5

In Example 5, a solid electrolytic capacitor A5 was produced in the same manner as in Example 1 except that a mixture of an aqueous solution containing 0.1% by weight of sodium tungstate and an aqueous solution containing 0.1% by weight of ammonium vanadate was used in place of the aqueous solution containing 0.1% by weight of sodium tungstate in the process 2A.

### Example 6

In Example 6, a solid electrolytic capacitor A6 was produced in the same manner as in Example 1 except that a mixture of an aqueous solution containing 0.1% by weight of sodium tungstate and an aqueous solution containing 0.1% by weight of sodium molybdate was used in place of the aqueous solution containing 0.1% by weight of sodium tungstate in the process 2A.

### Example 7

In Example 7, a solid electrolytic capacitor A7 was produced in the same manner as in Example 1 except that a mixture of an aqueous solution containing 0.1% by weight of sodium tungstate and an aqueous solution containing 0.1% by weight of sodium chromate was used in place of the aqueous solution containing 0.1% by weight of sodium tungstate in the process 2A.

### Example 8

In Example 8, a solid electrolytic capacitor A8 was produced in the same manner as in Example 1 except that a mixture of an aqueous solution containing 0.1% by weight of sodium molybdate and an aqueous solution containing 0.1% by weight of ammonium vanadate was used in place of the aqueous solution containing 0.1% by weight of sodium tungstate in the process 2A.

### Comparative Example 1

In Comparative Example 1, a solid electrolytic capacitor X1 was produced in the same manner as in Example 1 except that an aqueous solution containing 0.1% by weight of nitric acid was used in place of the aqueous solution containing 0.1% by weight of sodium tungstate in the process 2A.

### Comparative Example 2

In Comparative Example 2, a solid electrolytic capacitor X2 was produced in the same manner as in Comparative Example 1 except that the anode body 1 was nitrided (in a nitrogen atmosphere under a pressure of 0.04 MPa at a temperature of 300° C. for 5 minutes) after the anode body 1 was formed of a niobium porous sintered substance in the process 1A.

(Evaluation)

First, the solid electrolytic capacitor A1 according to Example 1 was subjected to chemical composition analysis. FIG. 2 is a graph showing a result of measurement of the solid electrolytic capacitor A1 by an XPS (X-ray Photoelectron Spectroscopy) method. Incidentally, a sample having no cathode (neither conductive polymer layer nor cathode layer) formed was used at the time of measurement. In FIG. 2, the vertical axis shows the amount of each element contained in the solid electrolytic capacitor, and the horizontal axis shows a depth from the cathode side surface of the dielectric layer.

As shown in FIG. 2, the dielectric layer of the solid electrolytic capacitor A1 according to Example 1 is made of niobium oxide containing niobium (Nb) and oxygen (O) as main components. Since the distribution of oxygen is substantially zero at a depth of about 25 nm from the cathode side surface, it is proved that the thickness of the dielectric layer is about 25 nm. The dielectric layer further contains tungsten (W). Tungsten is unevenly distributed so as to be lopsidedly inclined toward the cathode side surface of the dielectric layer. That is, tungsten is distributed with such a concentration gradient that the concentration of tungsten increases as the position of measurement approaches the cathode side surface of the dielectric layer.

As a result of chemical composition analysis of Examples 2 (solid electrolytic capacitor A2) to 5 (solid electrolytic capacitor A5), the dielectric layer contains each metal element of molybdenum (Example 2), vanadium (Example 3), chromium (Example 4), and tungsten and vanadium (Example 5). Each metal element is unevenly distributed so as to be lopsidedly inclined toward the cathode side surface of the dielectric layer in the same manner as in Example 1. That is, each metal element has such a concentration gradient that the concentration of the metal element increases as the position of measurement approaches the cathode side surface of the dielectric layer.

Next, a leakage current in each of various solid electrolytic capacitors was evaluated. Table 1 shows a result of evaluation of the leakage current in each solid electrolytic capacitor. The leakage current was measured as a current 20 seconds after a voltage of 2.5 V was applied to the solid electrolytic capacitor. Incidentally, the measured value of each leakage current is standardized in the condition that the measured result of the leakage current in the solid electrolytic capacitor A1 according to Example 1 is regarded as 100.

TABLE 1

| | | | Metal | |
|---|---|---|---|---|
| | | | Element | |
| | | | contained in | |
| | | Anode | Dielectric | Leakage |
| | | Material | Layer | Current¹⁾ |
| Example 1 | Solid electrolytic | Niobium | W | 100 |
| | capacitor A1 | | | |
| Example 2 | Solid electrolytic | Niobium | Mo | 105 |
| | capacitor A2 | | | |
| Example 3 | Solid electrolytic | Niobium | V | 102 |
| | capacitor A3 | | | |
| Example 4 | Solid electrolytic | Niobium | Cr | 106 |
| | capacitor A4 | | | |
| Example 5 | Solid electrolytic | Niobium | W + V | 90 |
| | capacitor A5 | | | |
| Example 6 | Solid electrolytic | Niobium | W + Mo | 93 |
| | capacitor A6 | | | |
| Example 7 | Solid electrolytic | Niobium | W + Cr | 94 |
| | capacitor A7 | | | |
| Example 8 | Solid electrolytic | Niobium | Mo + V | 96 |
| | capacitor A8 | | | |
| Comparative | Solid electrolytic | Niobium | — | 400 |
| Example 1 | capacitor X1 | | | |
| Comparative | Solid electrolytic | Niobium | — | 200 |
| Example 2 | capacitor X2 | Nitride | | |

¹⁾Standardization was made in the condition that the leakage current in Example 1 (solid electrolytic capacitor A1) was regarded as 100.

As shown in Table 1, the leakage current in Example 1 (solid electrolytic capacitor A1) is reduced remarkably compared with the leakage current in Comparative Example 1 (solid electrolytic capacitor X1) having the related-art dielectric layer. The leakage current in Example 1 is reduced also compared with the leakage current in Comparative Example 2 (solid electrolytic capacitor X2) having nitrogen (N) introduced into the dielectric layer. In this manner, since tungsten is unevenly distributed so as to be lopsidedly inclined toward the cathode side surface of the dielectric layer, the leakage current in the solid electrolytic capacitor can be reduced.

Also in the case of molybdenum (Example 2), vanadium (Example 3) or chromium (Example 4) used as a metal element contained in the dielectric layer, the leakage current is reduced to the same degree as in the case of tungsten (Example 1). In the case of tungsten and vanadium (Example 5), the leakage current becomes lower than that in the case where tungsten or vanadium is contained singly. Also in the case of Example 6, Example 7 or Example 8, the leakage current becomes lower than that in the case where each metal element is contained singly.

It is proved from the above description that the dielectric layer containing a metal element which is selected from the group consisting of tungsten, molybdenum, vanadium and chromium and which is unevenly distributed so as to be lopsidedly inclined toward the cathode side (conductive polymer layer side) is effective in reducing the leakage current in the solid electrolytic capacitor.

Next, the influence on reduction of the leakage current, of fluorine (F) and phosphorus (P) further contained in the metal element-containing dielectric layer was evaluated.

### Example 9

In Example 9, a solid electrolytic capacitor A9 was produced in the same manner as in Example 1 except that after tungsten was contained in the dielectric layer in the process 2A, anodic oxidation was further performed at a constant voltage of about 10 V for about 2 hours in an aqueous solution containing about 0.1% by weight of ammonium fluoride kept at about 60° C.

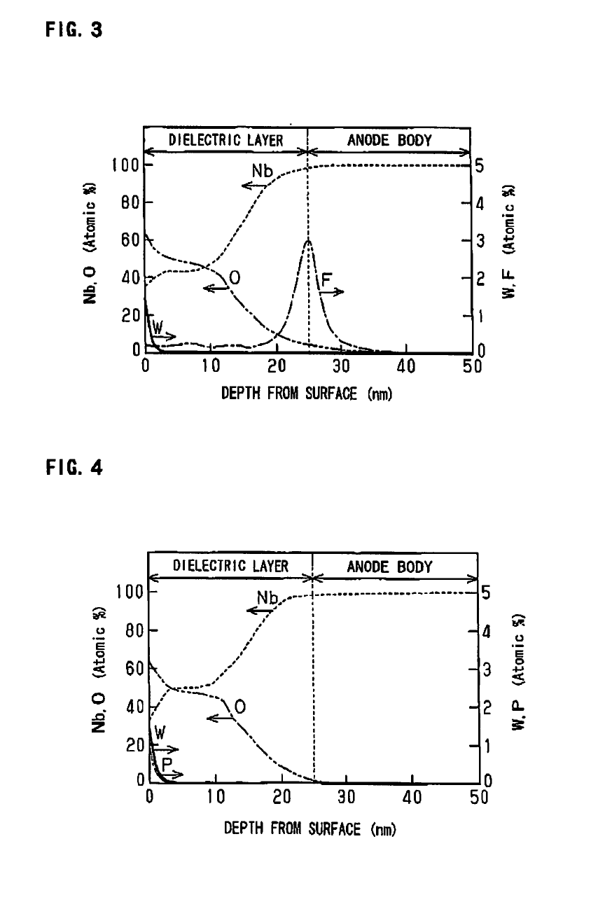

As a result of chemical composition analysis performed by an XPS method in the same manner as in Example 1, it was proved that a dielectric layer of niobium oxide having a thickness of about 25 nm was formed while doped not only with tungsten but also with fluorine as shown in FIG. 3. Incidentally, such fluorine has a concentration distribution in a direction of the thickness of the dielectric layer so that the concentration of fluorine is maximized at an interface between the dielectric layer and the anode body.

### Example 10

In Example 10, a solid electrolytic capacitor A10 was produced in the same manner as in Example 1 except that after tungsten was contained in the dielectric layer in the process 2A, anodic oxidation was further performed at a constant voltage of about 10 V for about 2 hours in an aqueous solution containing about 0.1% by weight of phosphoric acid kept at about 60° C.

As a result of chemical composition analysis performed by an XPS method in the same manner as in Example 1, it was proved that a dielectric layer of niobium oxide having a thickness of about 25 nm was formed while doped not only with tungsten but also with phosphorus as shown in FIG. 4. Incidentally, such phosphorus has a concentration distribution in a direction of the thickness of the dielectric layer so that the concentration of phosphorus is maximized at an interface between the dielectric layer and the conductive polymer layer.

### Example 11

In Example 11, a solid electrolytic capacitor A11 was produced in the same manner as in Example 1 except that after tungsten was contained in the dielectric layer in the process 2A, anodic oxidation was performed at a constant voltage of about 10 V for about 2 hours in an aqueous solution containing about 0.1% by weight of ammonium fluoride kept at about 60° C. and anodic oxidation was further performed at a constant voltage of about 10 V for about 2 hours in an aqueous solution containing about 0.1% by weight of phosphoric acid kept at about 60° C.

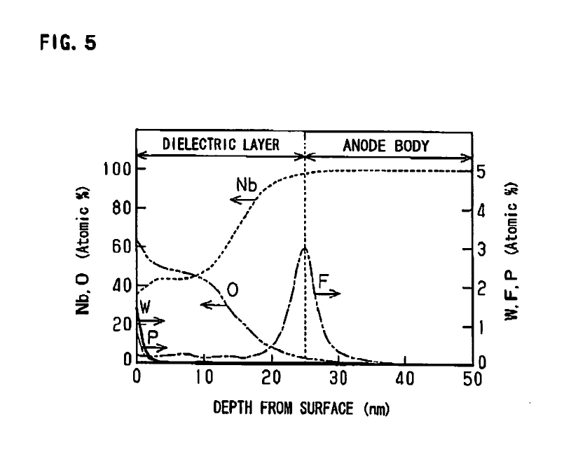

As a result of chemical composition analysis performed by an XPS method in the same manner as in Example 1, it was proved that a dielectric layer of niobium oxide having a thickness of about 25 nm was formed while doped not only with tungsten but also with fluorine and phosphorus as shown in FIG. 5. Incidentally, each of such fluorine and phosphorus has a concentration distribution in a direction of the thickness of the dielectric layer so that the concentration of fluorine is maximized at an interface between the dielectric layer and the anode body whereas the concentration of phosphorus is maximized at an interface between the dielectric layer and the conductive polymer layer.

### Comparative Example 3

In Comparative Example 3, a solid electrolytic capacitor X3 was produced in the same manner as in Example 1 except that after anodic oxidation was performed in an aqueous solution containing 0.1% by weight of nitric acid instead of the aqueous solution containing 0.1% by weight of sodium tungstate in the process 2A, anodic oxidation was further performed at a constant voltage of about 10 V for about 2 hours in an aqueous solution containing about 0.1% by weight of ammonium fluoride kept at about 60° C. As a result, the dielectric layer is doped with fluorine in the same manner as in Example 9.

### Comparative Example 4

In Comparative Example 4, a solid electrolytic capacitor X4 was produced in the same manner as in Example 1 except that after anodic oxidation was performed in an aqueous solution containing 0.1% by weight of nitric acid instead of the aqueous solution containing 0.1% by weight of sodium tungstate in the process 2A, anodic oxidation was further performed at a constant voltage of about 10 V for about 2 hours in an aqueous solution containing about 0.1% by weight of phosphoric acid kept at about 60° C. As a result, the dielectric layer is doped with phosphorus in the same manner as in Example 10.

(Evaluation)

The leakage current in each of the aforementioned various solid electrolytic capacitors was evaluated. Table 2 shows a result of evaluation of the leakage current in each solid electrolytic capacitor. The leakage current was measured as a current 20 seconds after a voltage of 2.5 V was applied to the solid electrolytic capacitor, in the same manner as the aforementioned evaluation. Incidentally, the measured value of each leakage current is standardized in the condition that the measured result of the leakage current in the solid electrolytic capacitor A1 according to Example 1 is regarded as 100.

TABLE 2

| | | Dielectric Layer | | | |
|---|---|---|---|---|---|
| | | | | Phos- | |
| | | Tungsten | Fluorine | phorus | Leakage |
| | | (W) | (F) | (P) | Current¹⁾ |
| Example 1 | Solid | Present | — | — | 100 |
| | electrolytic | | | | |
| | capacitor A1 | | | | |
| Example 9 | Solid | Present | Present | — | 95 |
| | electrolytic | | | | |
| | capacitor A9 | | | | |
| Example 10 | Solid | Present | — | Present | 90 |
| | electrolytic | | | | |
| | capacitor A10 | | | | |
| Example 11 | Solid | Present | Present | Present | 75 |
| | electrolytic | | | | |
| | capacitor A11 | | | | |
| Comparative | Solid | — | Present | — | 130 |
| Example 3 | electrolytic | | | | |
| | capacitor X3 | | | | |
| Comparative | Solid | — | — | Present | 125 |
| Example 4 | electrolytic | | | | |
| | capacitor X4 | | | | |

¹⁾Standardization was made in the condition that the leakage current in Example 1 (solid electrolytic capacitor A1) was regarded as 100.

As shown in Table 2, the leakage current in Example 1 (solid electrolytic capacitor A1) is reduced compared with the leakage current in Comparative Example 3 (solid electrolytic capacitor X3) having the related-art dielectric layer doped with fluorine and the leakage current in Comparative Example 4 (solid electrolytic capacitor X4) having the related-art dielectric layer doped with phosphorus. In this manner, since tungsten is unevenly distributed so as to be lopsidedly inclined toward the cathode side surface of the dielectric layer, the leakage current in the solid electrolytic capacitor can become lower than the leakage current in the case where the related-art dielectric layer is doped with fluorine or phosphorus.

In Example 9 (solid electrolytic capacitor A9) in which the dielectric layer is doped not only with tungsten but also with fluorine, the leakage current becomes lower than the leakage current in the case (Example 1) where the dielectric layer is doped only with tungsten. Also in Example 10 (solid electrolytic capacitor A10) in which the dielectric layer is doped with phosphorus instead of fluorine, the leakage current is reduced in the same manner as in the case of fluorine. In Example 11 (solid electrolytic capacitor A11) in which the dielectric layer is doped not only with tungsten but also with fluorine and phosphorus, the leakage current is reduced more remarkably.

It is proved from the above description that the dielectric layer containing fluorine or phosphorus in addition to tungsten unevenly distributed in the dielectric layer is effective in further reducing the leakage current in the solid electrolytic capacitor.

According to the solid electrolytic capacitor and the method for producing the solid electrolytic capacitor in this embodiment, the following effects can be obtained.

(1) Since at least one metal element selected from the group consisting of tungsten, molybdenum, vanadium and chromium is contained in the dielectric layer 2 and unevenly distributed so as to be lopsidedly inclined toward the cathode side (conductive polymer layer 3 side), oxygen is stably present in the dielectric layer 2 on the cathode side. Accordingly, amorphous niobium oxide functioning as the dielectric layer 2 is restrained from being crystallized when a heat load is applied, so that cracks are restrained from occurring from the dielectric layer 2 on the cathode side. As a result, increase of the leakage current in the solid electrolytic capacitor is restrained from being caused by the heat load.

(2) Since the metal element in the dielectric layer 2 is provided so as to be present in the neighborhood of the cathode side surface (i.e. in the neighborhood of an interface between the dielectric layer 2 and the conductive polymer layer 3), the state of the dielectric layer 2 in the neighborhood of the cathode side surface can be stabilized so effectively that the effect (1) can be enjoyed more remarkably.

(3) Since the metal element in the dielectric layer 2 has a concentration distribution in a direction of the thickness of the dielectric layer 2 so that the concentration of the metal element is maximized at an interface between the dielectric layer 2 and the conductive polymer layer 3, the state of the dielectric layer 2 in the neighborhood of the cathode side surface can be stabilized so more effectively that the effect (2) can be enjoyed more remarkably.

(4) Since fluorine is further contained in the dielectric layer 2 and provided so as to be present in the neighborhood of the anode side surface (i.e. in the neighborhood of an interface between the dielectric layer 2 and the anode body 1), oxygen is restrained from being diffused from the dielectric layer 2 to the anode body 1. As a result, the thickness of the dielectric layer 2 is restrained from being reduced, so that the leakage current in the solid electrolytic capacitor can be reduced more sufficiently.

This is based on the inference that a fluoride layer is formed in the neighborhood of an interface between the dielectric layer 2 and the anode body 1 because fluorine is provided so as to be present in the neighborhood of the interface between the dielectric layer 2 and the anode body 1 (i.e. in the neighborhood of the anode side surface). That is, it is inferred that a fluorine-containing region in the neighborhood of the interface between the dielectric layer 2 and the anode body 1 functions as a block layer which restrains oxygen from being diffused from the dielectric layer 2 to the anode body 1. As a result, oxygen is stably present in the dielectric layer 2, so that the state of the dielectric layer against a heat load is stabilized.

(5) Since fluorine has a concentration distribution in a direction of the thickness of the dielectric layer 2 so that the concentration of fluorine is maximized at an interface between the dielectric layer 2 and the anode body 1, oxygen is more effectively restrained from being diffused from the dielectric layer 2 to the anode body 1. As a result, the effect (4) can be enjoyed more remarkably.

(6) Since phosphorus is further contained in the dielectric layer 2 and provided so as to be present in the neighborhood of the cathode side surface (i.e. in the neighborhood of an interface between the dielectric layer 2 and the conductive polymer layer 3), the effect (1) is further intensified so that increase of the leakage current in the solid electrolytic capacitor can be more remarkably restrained from being caused by a heat load.

(7) Since phosphorus has a concentration distribution in a direction of the thickness of the dielectric layer 2 so that the concentration of phosphorus is maximized at an interface between the dielectric layer 2 and the conductive polymer layer 3, the effect (6) can be enjoyed more remarkably.

(8) According to this producing method, there can be produced a solid electrolytic capacitor having a dielectric layer 2 doped with at least one metal element which is selected from the group consisting of tungsten, molybdenum, vanadium and chromium and which is unevenly distributed so as to be lopsidedly inclined toward the cathode side surface of the dielectric layer 2. Accordingly, the state of the dielectric layer 2 in the neighborhood of the cathode side surface can be stabilized against a heat load, so that amorphous niobium oxide functioning as the dielectric layer is restrained from being crystallized. As a result, increase of the leakage current in the solid electrolytic capacitor is restrained. Accordingly, a solid electrolytic capacitor in which increase of the leakage current is restrained can be produced easily.

(9) According to this producing method, metallic acid ions (tungstic acid ions, molybdic acid ions, vanadic acid ions or chromic acid ions) containing at least one metal element selected from the group consisting of tungsten, molybdenum, vanadium and chromium can be contained in the dielectric layer. Accordingly, a solid electrolytic capacitor in which increase of the leakage current is more sufficiently restrained can be produced easily.

(10) After anodic oxidation is performed in an aqueous solution containing metallic acid ions, anodic oxidation is further performed in an electrolyte solution containing fluorine such as ammonium fluoride so that fluorine as well as the metal element can be contained in the dielectric layer 2. Particularly, fluorine can be contained easily so as to be unevenly distributed in the neighborhood of the anode side surface (i.e. in the neighborhood of an interface between the dielectric layer 2 and the anode body 1). As a result, in addition to the effect of the metal element stabilizing the dielectric layer 2, oxygen is restrained from being diffused from the dielectric layer 2 to the anode body 1. Therefore, according to this producing method, a solid electrolytic capacitor in which increase of the leakage current is more sufficiently restrained can be produced easily.

(11) After anodic oxidation is performed in an aqueous solution containing metallic acid ions, anodic oxidation is further performed in an aqueous solution containing phosphoric acid so that phosphorus as well as the metal element can be contained in the dielectric layer 2. Particularly, phosphorus can be contained easily so as to be unevenly distributed in the neighborhood of the cathode side surface (i.e. in the neighborhood of an interface between the dielectric layer 2 and the conductive polymer layer 3). As a result, the effect of the metal element and phosphorus stabilizing the state of the dielectric layer 2 in the neighborhood of the cathode side surface becomes more remarkable. Therefore, according to this producing method, a solid electrolytic capacitor in which increase of the leakage current is more sufficiently restrained can be produced easily.

(12) After anodic oxidation is performed in an aqueous solution containing metallic acid ions, anodic oxidation in an aqueous solution of ammonium fluoride and anodic oxidation in an aqueous solution of phosphoric acid are performed continuously so that fluorine and phosphorus as well as the metal element can be contained in the dielectric layer 2. According to this producing method, a solid electrolytic capacitor in which increase of the leakage current is more sufficiently restrained by the synergistic effect of the metal element, fluorine and phosphorus can be produced easily.

Incidentally, the invention is not limited to the aforementioned embodiment (examples). Various changes such as design changes can be made based on the knowledge of those skilled in the art. Embodiments (examples) subjected to such changes may be included in the scope of the invention.

Although the embodiment has been described on the case where the concentration of the metal element is maximized at an interface between the dielectric layer and the conductive polymer layer and the whole of the concentration distribution of the metal element is located on the conductive polymer layer side with respect to a half of the thickness of the dielectric layer, the invention is not limited thereto. For example, a part of the concentration distribution of the metal element may be located on the conductive polymer layer side with respect to a half of the thickness of the dielectric layer. In this case, the aforementioned effect can be enjoyed in a portion where at least a maximized concentration region in the concentration distribution of the metal element is located on the conductive polymer layer side.

In the aforementioned embodiment, the conductive polymer layer and the dielectric layer need not touch each other in the whole region of the capacitor as long as the metal element is contained in the dielectric layer and unevenly distributed so as to be lopsidedly inclined toward the cathode side (i.e. conductive polymer layer side) at least in all or part of a region where the conductive polymer layer and the dielectric layer touch each other.

Although the examples have been described on the case where tungsten and vanadium are used in combination (Example 5), on the case where tungsten and molybdenum are used in combination (Example 6), on the case where tungsten and chromium are used in combination (Example 7) and on the case where molybdenum and vanadium are used in combination (Example 8), the invention is not limited thereto. For example, other two kinds of metal elements such as vanadium and chromium may be used in combination or three or more kinds of metal elements may be used in combination. Also in these cases, the aforementioned effects can be enjoyed.

Although the examples have been described on the case where an aqueous solution of ammonium fluoride is used as an electrolyte solution containing fluorine, the invention is not limited thereto. For example, an aqueous solution of potassium fluoride, an aqueous solution of sodium fluoride, an aqueous solution of hydrofluoric acid or the like may be used as an electrolyte solution. Or these electrolyte solutions may be used in combination. Also in these cases, at least the effects (4) and (5) can be enjoyed.

What is claimed is:

1. A solid electrolytic capacitor comprising:
an anode made of niobium or a niobium alloy;
a dielectric layer formed on a surface of the anode and containing niobium oxide; and
a cathode including a conductive polymer layer formed on the dielectric layer;
wherein the dielectric layer contains at least one metal element which is selected from the group consisting of tungsten, molybdenum, vanadium and chromium and which is distributed so as to be lopsidedly inclined toward the cathode side.

2. A solid electrolytic capacitor according to claim 1, wherein the metal element is present at an interface between the dielectric layer and the conductive polymer layer.

3. A solid electrolytic capacitor according to claim 2, wherein the metal element has a concentration distribution in a direction of thickness of the dielectric layer so that the concentration of the metal element is maximized at the interface between the dielectric layer and the conductive polymer layer.

4. A solid electrolytic capacitor according to claim 1, wherein the dielectric layer further contains fluorine so that the fluorine is present at an interface between the dielectric layer and the anode.

5. A solid electrolytic capacitor according to claim 1, wherein the dielectric layer further contains phosphorus so that the phosphorus is present at the interface between the dielectric layer and the conductive polymer layer.

6. A method of producing a solid electrolytic capacitor, comprising:
the first step of performing anodic oxidation on a surface of an anode made of niobium or a niobium alloy in an aqueous solution containing metallic acid ions selected from the group consisting of tungstic acid ions, molybdic acid ions, vanadic acid ions and chromic acid ions to thereby form a dielectric layer containing niobium oxide and dope the dielectric layer with the metallic acid ions; and
the second step of forming a cathode including a conductive polymer layer on the dielectric layer.

7. A method of producing a solid electrolytic capacitor according to claim 6, further comprising the third step of performing anodic oxidation in an aqueous solution containing fluorine ions to thereby dope the dielectric layer with fluorine, wherein the third step is executed between the first step and the second step.

8. A method of producing a solid electrolytic capacitor according to claim 7, further comprising the fourth step of performing anodic oxidation in an aqueous solution containing phosphoric acid ions to thereby dope the dielectric layer with phosphorus, wherein the fourth step follows the third step.
